(19) United States
(12) Patent Application Publication
(10) Pub. No.: US 2024/0232810 A9
(43) Pub. Date: Jul. 11, 2024

(54) SYSTEMS AND METHODS FOR MANAGING OFFBOARDING OF EMPLOYEES

(71) Applicant: ZLURI TECHNOLOGIES PRIVATE LIMITED, Hyderabad (IN)

(72) Inventors: Chaithanya YEMBARI, Hyderabad (IN); Sethu Meenakshisundaram, Hyderabad (IN); Ritish Reddy, Hyderabad (IN); Shivam Verma, Hyderabad (IN); Paritosh Lokhande, Hyderabad (IN); Yatharth Singh, Hyaderabad (IN)

(21) Appl. No.: 18/082,369

(22) Filed: Dec. 15, 2022

(30) Foreign Application Priority Data
Oct. 19, 2022 (IN) 202241059875

(51) Int. Cl. G06Q 10/1053; G06F 21/41

(52) U.S. Cl. CPC G06Q 10/1053; G06F 21/41

(57) ABSTRACT

A system and method for managing offboarding of employees. Applications used by an employee are identified. Further, insights for the applications are derived. The insights comprise a category for the applications. The applications are arranged in a sequence based on a priority. Subsequently a set of actions for the applications are determined based on the insights. Finally, the set of actions are scheduled to be automatically executed using APIs.

### PRIORITY INFORMATION

The present application claims priority from Indian application no. 202241059875 filed on 19 Oct. 2022.

### TECHNICAL FIELD

The present subject matter described herein, in general, relates to a SaaS management platform for managing offboarding of employees for a company.

### BACKGROUND

With the proliferation of applications or software to run businesses these days, the offboarding of an employee in an organization has become a challenging task. This is because the employee may have used several application/software tools to carry out his/her business tasks and there may be several dependencies on the information on these applications within the team or department. So, when an employee leaves an organization, simply removing the employee's access to these applications may disrupt business workflows and may even result in loss of data. With so much at stake, the company cannot leave the task of managing the applications to the employee being offboarded. Therefore, there is a need for a robust system and method for efficiently managing the offboarding of employees.

### SUMMARY

Before the present system(s) and method(s), are described, it is to be understood that this application is not limited to the particular system(s), and methodologies described, as there can be multiple possible embodiments which are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for unique recommendation algorithm for managing offboarding of an employee via a SaaS management platform. This summary is not intended to identify essential features of the claimed subject matter nor is it intended for use in determining or limiting the scope of the claimed subject matter.

In one implementation, a method for managing offboarding of employees disclosed in the invention. The method may comprise receiving a request to offboard an employee. Further, the method may comprise extracting employee data from a company database. The employee data may comprise employee role, employee connections, and a list of applications used by the employee. Further, application data related to the list of applications may be received from disparate sources, wherein the disparate sources include at least single sign on (SSO) integration, application integration, expense log integration, browser extension and desktop agent.

Subsequently, one or more insights for each application may be derived based on the employee data and application data. The insights may be derived using machine learning algorithms. The insights may comprise a category assigned to each application, access rights and application usage pattern. Subsequently, the method may comprise determining a set of actions for the applications based on the insights and a set of company rules. The set of actions may be determined using machine learning algorithms. The set of actions may comprise at least one of resource management, revoke access control, deactivation, and recommending an action to the employee. Finally, the method may comprise automatically scheduling the set of actions for the applications based on the insights, employee data, and application data.

For automatically scheduling the set of actions, the method may comprise arranging the applications in a sequence based on priority of the applications. The priority may be dynamically computed based on the set of company rules, and application data. The priority may be computed using a machine learning algorithm. Further, the method may comprise scheduling the set of actions for the applications following the sequence. Subsequently, the method may comprise receiving a feedback from an administrative entity for the sequence and schedule of the set of actions. The administrative entity may be at least one of an error management system, and a human participant. The administrative entity may be assigned automatically based on the employee data and the insights. Finally, the method may comprise continuously modifying the schedule based on the feedback.

In an embodiment, the method may comprise maintaining a status log of the set of actions. The status log may comprise a status of the set of actions performed. The status may be either a completed status or a pending status. Further, the method may comprise identifying a cause for the pending status for an action. The cause may be at least one of broken APIs, permission or security error, and incorrect schedule. Further, the method may comprise reporting the actions having the pending status and the cause to the administrative entity. Subsequently, the method may comprise receiving a new set of actions from the administrative entity. In another embodiment, a new set of actions may be received when an application is not present in the set of company rules. Finally, the method may comprise dynamically modifying the set of company rules based on the new set of actions.

In another implementation, a non-transitory computer program product embodying a program executable in a computing device is disclosed for managing offboarding of employees. The program may comprise a program code for receiving a request to offboard an employee. Further, the program may comprise a program code for extracting employee data from a company database. The employee data may comprise employee role, employee connections, and a list of applications used by the employee. Further, application data related to the list of applications may be received from disparate sources, wherein the disparate sources include at least single sign on (SSO) integration, application integration, expense log integration, browser extension and desktop agent.

Subsequently, one or more insights for each application may be derived based on the employee data and application data. The insights may be derived using machine learning algorithms. The insights may comprise a category assigned to each application, access rights and application usage pattern. Subsequently, the program may comprise a program code for determining a set of actions for the applications based on the insights and a set of company rules. The set of actions may be determined using machine learning algorithms. The set of actions may comprise at least one of resource management, revoke access control, deactivation, and recommending an action to the employee. Finally, the program may comprise a program code for automatically scheduling the set of actions for the applications based on the insights, employee data, and application data.

In one aspect, the aforementioned method for managing offboarding of employees may be performed by a processor using programmed instructions stored in a memory.

In another implementation, a non-transitory computer readable medium embodying a program executable in a computing device for managing offboarding of employees for a company is disclosed.

### BRIEF DESCRIPTION OF THE DRAWINGS

The foregoing detailed description of embodiments is better understood when read in conjunction with the appended drawings. For the purpose of illustrating of the present subject matter, an example of a construction of the present subject matter is provided as figures, however, the invention is not limited to the specific method and system for managing offboarding of employees for a company.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a network implementation 100 of a system 102 to manage offboarding of employees for a company.

FIG. 2 illustrates a method 200 to manage offboarding of employees with an embodiment of the present subject matter.

FIG. 3 illustrates an example implementation of a system console used for managing offboarding workflows.

FIG. 4 illustrates an example implementation of a status log maintained by the system.

FIG. 5 illustrates an example artificial neural network, in accordance with an embodiment of the present subject matter.

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “receiving,” “extracting” “determining,” “identifying,” “deriving,” “scheduling,” and other forms thereof, are intended to be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The present subject matter discloses a method and a system for managing offboarding of employees for a company. For offboarding an employee, either the employee's access to some applications must be revoked or employee's account must be deactivated. Important data must also be saved before deactivating the employee's account. Initially, a request for offboarding an employee may be received. Further, employee data of the employee may be extracted. The employee data may comprise employee role, employee connections, and a list of applications. Further, application data for applications from the list of applications may be received.

Further, insights may be derived for each application based on the application data and the employee data. The insights may include information on a type or category of each application. The category may be one of “Managed,” “Unmanaged,” and “Restricted”. The insights may also comprise access rights required for each application and application usage pattern of the employee. Subsequently, a set of actions for each application may be determined based on the insights and a set of company rules comprising a predefined set of actions for one or more applications. For example, the set of company rules may comprise deactivation of an employee account directly as predefined set of actions for Application A, resource management and deactivation as predefined set of actions for Application B. Finally, the set of actions for the applications may be scheduled automatically based on the insights, the employee data, and the application data using APIs.

Certain technical challenges exist for managing offboarding of employees. One technical challenge faced while scheduling the automatic deactivation of multiple applications is that the applications may be dependent on each other. For example, an application 1, required for accessing data in application 2, cannot be deactivated before application 2. The solutions presented by the embodiments disclosed herein to address the above challenge are one or more machine learning algorithms trained using recursive learning techniques. The machine learning algorithms may be trained to compute a priority of the multiple applications based on application data and feedback received from the administrative entity. The one or more machine learning models may comprise Logistic Regression, Naive Bayes, K-Nearest Neighbours, Decision Tree, Support Vector Machines.

Another technical challenge includes automatically assigning an administrative entity for an employee. The administrative entity may be at least one of an error management system, and a human participant. The solution presented by the embodiments disclosed herein to address this challenge includes machine learning algorithms that may be trained to process employee data of a company to determine hierarchy of employees based on employee roles.

Certain embodiments disclosed herein may provide one or more technical advantages. A technical advantage of the embodiments may include automatically scheduling a set of actions for a list of applications. Another technical advantage may include automatically assigning an administrative entity for an employee in case a scheduled set of action remains incomplete or pending. Another technical advantage may include modifying a set of company rules based on feedback received from the administrative entity. Certain embodiments disclosed herein may provide none, some, or all of the above technical advantages. One or more other technical advantages may be readily apparent to one skilled in the art in view of the figures, descriptions, and claims of the present disclosure.

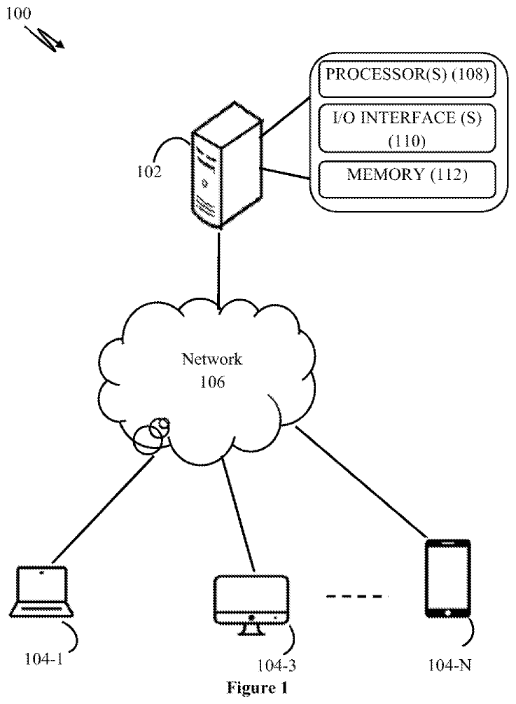

Referring now to FIG. 1, a network implementation 100 of a system 102 to manage offboarding of employees for a company is described herein. Initially, the system 102 may receive a request, from a user, for offboarding an employee. In an example, the software may be installed on a user device 104-1. It may be noted that the one or more users may access the system 102 through one or more user devices 104-1, 104-3, . . . 104-N, collectively referred to as user devices 104, hereinafter, or applications residing on the user devices 104. The system 102 may receive user information from a user. Further, the system may also 102 receive feedback from an administrative entity using at least one of the user devices 104, a network 106. Although the present disclosure is explained considering that the system 102 is implemented on a server, it may be understood that the system 102 may be implemented in a variety of computing systems, such as a laptop computer, a desktop computer, a notebook, a workstation, a virtual environment, a mainframe computer, a server, a network server, a cloud-based computing environment. It will be understood that the system 102 may be accessed by multiple users through one or more user devices 104-1, 104-3 . . . 104-N. In one implementation, the system 102 may comprise the cloud-based computing environment in which the user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through the network 106.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the system 102 may include at least one processor 108, an input/output (I/O) interface 110, and a memory 112. The at least one processor 108 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 108 is configured to fetch and execute computer-readable instructions stored in the memory 112.

The V/O interface 110 may include a variety of software and hardware interfaces, for example, a web interface, a graphical user interface, and the like. The I/O interface 110 may allow the system 102 to interact with the user directly or through the client devices 104. Further, the L/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, flash memories, hard disks, Solid State Disks (SSD), optical disks, and magnetic tapes. The memory 112 may include routines, programs, objects, components, data structures, etc., which perform particular tasks or implement particular abstract data types. The memory 112 may include programs or coded instructions that supplement applications and functions of the system 102. In one embodiment, the memory 112, amongst other things, serves as a repository for storing data processed, received, and generated by one or more of the programs or the coded instructions.

As there are various challenges observed in the existing art, the challenges necessitate the need to build the system 102 to manage offboarding of employees for a company. At first, a user may use the user device 104 to access the system 102 via the IO interface 110. The user may register the user devices 104 using the I/O interface 110 in order to use the system 102. In one aspect, the user may access the I/O interface 110 of the system 102. The detail functioning of the system 102 is described below with the help of figures.

The present subject matter discloses the system 102 to manage offboarding of employees for a company. Initially, the system may receive a request to offboard an employee. The request may be received from a user through a graphical user interface. The user may select one or more employees that need to be offboarded. The request may be received through an email. The email may be sent to a server ID programmed to run the system and offboard the employee mentioned in the email. In another embodiment, the company may have an Enterprise Resource Platform (ERP). The request may be received by the system when an employee submits a resignation on the ERP.

Further to receiving the request, the system may extract employee data comprising employee role, employee connections, and a list of applications used by the employee from a company database. The employee role may define the seniority, position, and responsibilities of the employee. The employee connections may comprise responsibilities shared with other employees, senior employees that the employee reports to, and junior employees that report to the employee. The list of applications used by the employee comprises one or more applications that the employee has accessed.

Further to extracting employee data, the system may extract application data for the one or more applications in the list of applications used by the employee from multiple sources. The one or more applications may include one or more tools or software used for performing day to day tasks of an employee in an organization. For example, applications such as Google's G Suite™, Slack©, Jira™, Zoom™, Salesforce™ etc. These applications also popularly known as Software as a Service (SaaS) applications or on demand software. Employees can connect to and use these cloud-based applications online as they are centrally hosted. The application data is received from a variety of sources and in a huge volume. The sources may include different integration platforms such as single sign on (SSO) integration platform, application integration platform and expense log integration platform. The SSO integration generally provides information related to the employee, email ID, access rights, application and log-alike in details etc., via an SSO provider for example Google Workspace™, Microsoft Azure™ AD, OKTA™ etc. Similarly, the application integration may provide usage details of any particular application, the different applications that are used/subscribed by a particular employee, a track record of log in times, license information about application etc. The expense log integration for example may provide information related to different financial transactions done in the organization through expense or finance management systems such as Quickbook™, NetSuite™ etc. For example, this expense log integration captures transaction details related to an application such as amount and date on which transaction was done. Further, this information is mapped with the corresponding application against which the particular transaction was done. These are a few examples of the application data that may be extracted from the multiple sources.

The different integration platforms used for obtaining application usage pattern operate with different applications via APIs. These APIs operate in such a way that it acts as a gateway between a web server and a SaaS application user to application usage pattern.

For example, a single sign on (SSO) which is a session and user authentication service lets users utilize one set of login credentials to access multiple applications. The SSO integration in this case when integrated directly with the identity providers like OKTA™, ONELOGiN™, Microsoft Azure™ AD and G Suite™ will provide one set of credentials like a username and a password to access different applications.

The employee data and the application data may then be used to derive insights such as usage pattern of these applications, category of application, security standards, access rights etc. The category of the applications may be Managed, Unmanaged, or Restricted. The insights may be derived using machine learning algorithms.

Managed—The applications that are pre-installed and mandatory for every employee. The company has control over the managed application. The company may perform a set of actions on the managed applications directly.

Unmanaged and Restricted—The applications that an employee may install at their own discretion are unmanaged and restricted applications. The company cannot perform any actions on the unmanaged and restricted applications.

The access rights are permissions an individual user or a computer application holds to read, write, modify, delete, or otherwise access a computer file. The access rights may be determined based on identifying what type of data is stored by or accessed through the application. For example, admin data, employee data, financial data, server data, and the like. The usage pattern may include frequency of use of the application, amount of time the application is used, features of the application used, and the like.

The machine learning algorithms may be trained to use application data, employee data as input and produce the above-mentioned insights as output. The machine learning algorithms may be trained on a training database comprising a set of applications labelled with a category. The machine learning algorithms may be trained with a training dataset comprising application data of a plurality of employees, and application usage patterns of the plurality of employees. The machine learning algorithms may be trained using a training dataset of employee data for a plurality of employees, application data, and access rights for the plurality of employees. The machine learning algorithms are trained to identify a category of an application that is unlabelled, application usage pattern for an employee based on application data, access rights of an application for an employee based on the application data and the employee data.

Further to deriving insights for the one or more applications in the list of applications used by the employee, the system may determine a set of actions for the one or more applications. The set of actions may be a levelling workflow that must be followed for retrieving data and deactivating an account of an employee being offboarded. The set of actions may comprise at least one of resource management, revoke access control, deactivation and recommending an action to the employee. The action may be removal of the application.

Resource management—Resource management includes retrieving data that is stored on the application by the employee.

Revoke access control—Revoke access control includes disallowing the employee to access the application. The employee may not be able to access any data saved on the application once the access control is revoked. The company may be using the employee's account to retrieve data while the employee's access is revoked.

Deactivation—Deactivation includes removal of the employee account from the application. Deactivation may also include deactivation of subscription of a license of the application or transfer of the subscription to another employee. After deactivation, neither the company, nor the employee can access the any data saved on the application by the employee using the employee's sign in credentials.

Recommended Action—Recommending removal of an application includes a message or a prompt to be sent to the employee suggesting the employing to sign out of the application and delete the application.

The set of actions may be determined based on the insights and a set of company rules. The set of company rules may include a pre-defined workflow or set of actions for a set of applications, access rights of an application for an employee based on the employee role, priority of an application based on the access rights. The set of applications may be applications that are licensed and paid for by the company. The set of actions may be determined by a machine learning algorithm. The machine learning algorithm may be trained to process the insights and select the set of actions based on the category of the application.

For example, if an application is under the restricted category, the machine learning algorithm may select the action “recommend removal” to the employee. The machine learning algorithm may be trained on a training data of set of actions and category of applications. The system may also use a rule-based algorithm in case the list of applications used by the employee and the category of the applications are directly available to the system.

Finally, the system may schedule the set of actions for the one or more applications in the list of applications used by the employee. The list of applications may comprise multiple applications with different access rights. In order to seamlessly deactivate all the applications, the system may arrange the applications in a sequence based on a priority of the applications. The priority of the applications may be calculated based on the set of company rules, the employee data, and the application data. The system may dynamically compute the priority of the one or more applications using a machine learning algorithm. The machine learning algorithm may be trained using a training data set comprising employee data for a plurality of employees, a plurality of a set of company rules, a set of applications used by the plurality of employees, priority of each application in the set of applications. The machine learning algorithm may be trained to compute priority of an application as an output for an input of employee data, application data, set of company rules. The priority of the application may be high when the application has more access rights. The application may have a high priority when the application is linked to higher number of other applications.

The system may follow the priority of the one or more applications to schedule the set of actions for the one or more applications. The system may schedule the set of actions starting from the lowest priority to the highest priority. First the application having the lowest priority is scheduled for “resource management”. The application is then scheduled for “revoke access control”. Finally, the application is scheduled for “deactivation”.

Each application may require a different set of actions to perform the above levelling framework. The system schedules the set of actions using APIs of the applications. For example, scheduling the levelling framework for an employee's email account may comprise scheduling the following tasks:

Resource Management—Backup Emails, Transfer/Forward emails to an admin ID, backup data stored on cloud server of the email platform, store the backup data on company server, clear all data, and alike.

Revoke access control—Whitelist admin server ID for access to the email account, change access credentials for the email ID, block employee's system IP address, and the like.

Deactivation—Delete email account, remove/transfer subscription if any, and alike.

The system may be integrated with the one or more applications using APIs to perform the set of actions automatically as scheduled. An API is a collection of functions and procedures that define how software components should interact with one another. They enable users to access the functionality of other software easily and quickly via well-defined data structures.

In an embodiment, the system may receive feedback from an administrative entity regarding the sequence of the applications and the schedule of the set of actions. The administrative entity may be at least an error management system, and a human participant. The error management system may use a machine learning algorithm trained to ensure completion of the set of actions as per the schedule. The machine learning algorithm may be trained using a training data set of employee data for a plurality of employees, set of company rules for a plurality of companies, application data, and set of actions. The machine learning algorithm may give an error, a suggestion to resolve the error, and a new set of actions as an output in case an action from a set of actions cannot be completed for an employee. The input for the machine learning algorithm may be employee data, application data, set of actions. The human participant may be an employee of the company responsible for offboarding of the employee. The administrative entity may be assigned based on the employee data. The system may use a machine learning algorithm to assign the administrative entity. The machine learning algorithm may be trained to assign the administrative entity based on the employee role. The machine learning algorithm may be trained on a training data set of employee data for a plurality of employees, administrative entity assigned, and errors in set of actions. The machine learning algorithm may be trained to assign a human participant in case an error is not resolved by the error management system. The machine learning algorithm may assign a human participant directly to employees having a predefined set of employee roles. The predefined set of employee roles may be provided by the company.

The administrative entity may provide feedback by accepting, rejecting, or modifying the sequence and the schedule. The system may use recursive learning to retrain the applicable machine learning algorithms based on the feedback. The system may modify the schedule for the set of actions based on the feedback.

In an embodiment, the system may maintain a status log of the set of actions scheduled for the employee. The status log may comprise the list of applications, the set of actions for each application, and the status of each action. The status may be either a completed status or a pending status. Further, the system may identify a cause for the pending status of an action. The cause may be at least one of broken APIs, permissions or security error, and incorrect schedule. Broken APIs may result in miscommunication between the system and the application causing the set of action to remain unperformed. Permissions or security error may be a result of change in company rules or application guidelines that may not be updated in the system, this may cause a failure in execution of the set of actions.

In case of an incorrect schedule, an application priority may be miscalculated by the system resulting in deactivation of an application having higher priority. The system may not be able to access any application dependent on the higher priority application that was deactivated.

Further, the system may report an action having the pending status and the cause to the administrative entity.

In an embodiment, the system may receive a new set of actions from the administrative entity to execute the pending actions. The list of applications used by the employee may comprise of an application that may not be in the set of company rules. The system may receive the new set of actions for the application from the administrative entity. The company rules and the schedule may be modified based on the new set of actions.

Consider an example, Employee A from Company X has to be offboarded. The system receives a request to offboard the Employee A. The system extracts employee data for the Employee A. Let us assume the employee data is:
Employee Role—Developer;
Employee connections—Employee B, Employee F. Employee H;
List of Applications used—App A, App B, App H, App Z.

The system receives application data for App A, App B, App H, App Z. Further, the system derives insights for the applications by processing the application data and employee data. Let us assume that the insights are:

| Application | Category | Usage Pattern | Access rights |
|---|---|---|---|
| App A | Managed | 5 hours a day | Admin Server |
| App B | Managed | 1 hour a day | Admin Server |
| App H | Unmanaged | 1 hour a day | Employee Server |
| App Z | Restricted | 3 hours a day | NA |

The system determines a set of actions for the applications based on the insights and the set of company rules. For App H and App Z, the set of actions are not predefined because the applications are not managed. In this case, the action is “recommend removal”. The employee is suggested to delete the App H and App Z. For App A and App B, the system determines the set of actions following the levelling framework: Resource Management; Revoke access control; Deactivation,

Let us assume that App A is an email application and App B, App H, App Z are linked to the email account of the Employee A. The system arranges the applications in a sequence based on a priority. In this example, the priority of App A is higher than App B since App B is dependent on App A. The system arranges the applications in a sequence of lowest priority to highest priority—App Z, App H, App B, App A.

The system then schedules the set of actions following the sequence:
For App Z and App H— The system recommends removal to the employee.
For App B—The system schedules the set of actions for resource management; revoke access control; deactivation.
Finally, for App A—The system schedules the set of actions for resource management; revoke access control; deactivation.

The system may use APIs of the applications to execute the scheduled set of actions. An API is an interface between a user/developer and a web application. This enables a seamless interaction between these two parties. Generally, API enables web application providers to open their application function/features and data to external third parties to build further applications or solve existing problems by accessing these functionalities/insights via APIs.

In an embodiment, the request to offboard an employee may comprise a date for offboarding. The system may schedule the set of actions for the date.

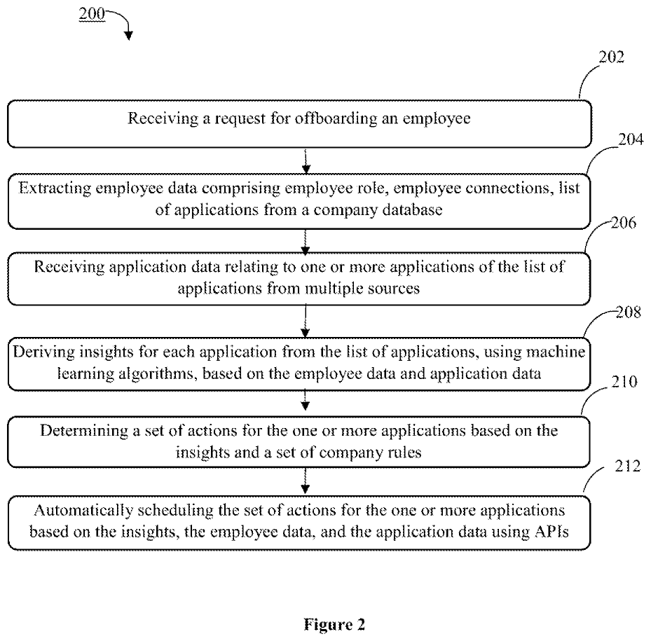

Referring now to FIG. 2, a method 200 to manage offboarding of employees is shown, in accordance with an embodiment of the present subject matter. The method 200 may be described in the general context of computer executable instructions. Generally, computer executable instructions can include routines, programs, objects, components, data structures, procedures, modules, functions, etc., that perform particular functions or implement particular abstract data types.

The order in which the method 200 is described is not intended to be construed as a limitation, and any number of the described method blocks can be combined in any order to implement the method 200 or alternate methods to manage offboarding of employees. Additionally, individual blocks may be deleted from the method 200 without departing from the scope of the subject matter described herein. Furthermore, the method 200 to manage offboarding of employees can be implemented in any suitable hardware, software, firmware, or combination thereof. However, for ease of explanation, in the embodiments described below the method 200 may be implemented in the above-described system 102.

At block 202, a request for offboarding an employee is received.

At block 204, employee data comprising employee role, employee connections, list of applications is extracted from a company database.

At block 206, application data relating to one or more applications of the list of applications is received from multiple sources.

At block 208, insights are derived for each application from the list of applications, using machine learning algorithms, based on the employee data and application data.

At block 210, a set of actions for the one or more applications is determined based on the insights and a set of company rules.

At block 212, the set of actions are automatically scheduled based on the insights, the employee data, and the application data using APIs.

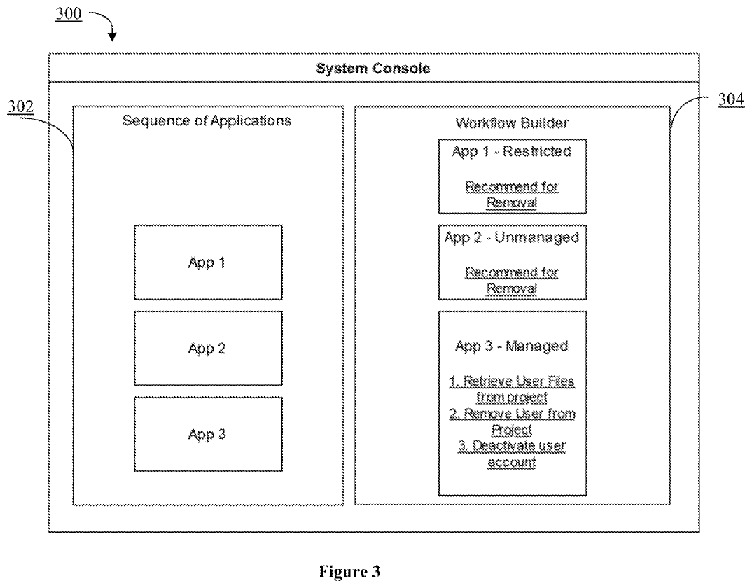

Referring now to FIG. 3, an embodiment of a system console 300 used by a user to operate the system 102 is illustrated. The system console comprises an application window 302. A sequence of applications is displayed in the application window. The system console further comprises a workflow builder window 304. The workflow builder window may be used by a human participant to accept, reject, or modify the set of actions displayed in the workflow builder window.

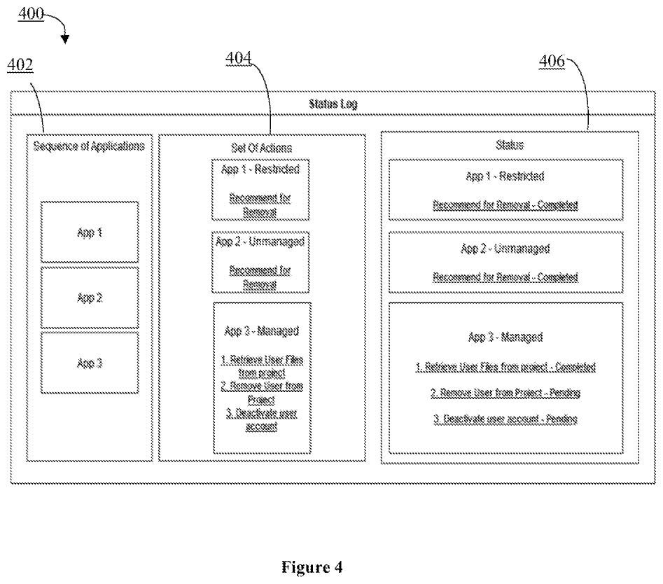

Referring now to FIG. 4, an embodiment of a status log window 400 maintained by the system is shown. The status log window comprises an application window 402, action window 404, status window 406. The application window displays the sequence of applications, the action window comprises the set of actions determined by the system for the applications, the status window displays the status of each action.

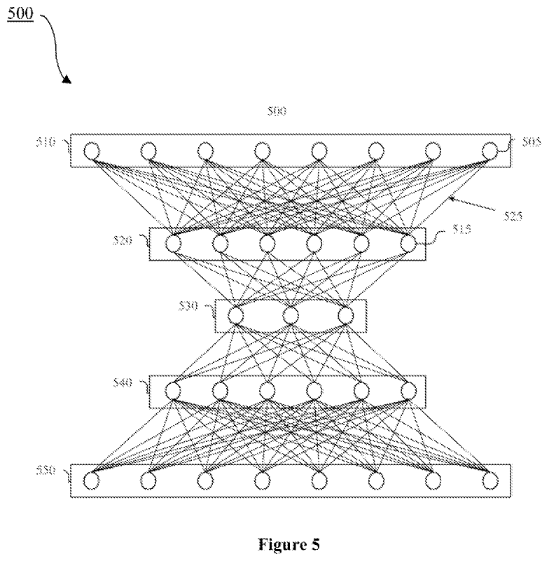

FIG. 5 illustrates an example artificial neural network (“ANN”) 500 of the machine learning algorithms. In particular embodiments, an ANN may refer to a computational model comprising one or more nodes. Example ANN 500 may comprise an input layer 510, hidden layers 520, 530, 560, and an output layer 550. Each layer of the ANN 500 may comprise one or more nodes, such as a node 505 or a node 515. In particular embodiments, each node of an ANN may be connected to another node of the ANN. As an example, and not by way of limitation, each node of the input layer 510 may be connected to one of more nodes of the hidden layer 520. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 5 depicts a particular ANN with a particular number of layers, a particular number of nodes, and particular connections between nodes, this disclosure contemplates any suitable ANN with any suitable number of layers, any suitable number of nodes, and any suitable connections between nodes. As an example, and not by way of limitation, although FIG. 5 depicts a connection between each node of the input layer 510 and each node of the hidden layer 520, one or more nodes of the input layer 510 may not be connected to one or more nodes of the hidden layer 520.

In particular embodiments, an ANN may be a feedforward ANN (e.g., an ANN with no cycles or loops where communication between nodes flows in one direction beginning with the input layer and proceeding to successive layers). As an example, and not by way of limitation, the input to each node of the hidden layer 520 may comprise the output of one or more nodes of the input layer 510. As another example and not by way of limitation, the input to each node of the output layer 550 may comprise the output of one or more nodes of the hidden layer 560. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example, and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example, and not by way of limitation, an activation function may be an identity function, a binary step function, a logistic function, or any other suitable function.

In particular embodiments, the input of an activation function corresponding to a node may be weighted. Each node may generate output using a corresponding activation function based on weighted inputs. In particular embodiments, each connection between nodes may be associated with a weight. As an example, and not by way of limitation, a connection 525 between the node 505 and the node 515 may have a weighting coefficient of 0.4, which may indicate that 0.4 times the output of the node 505 is used as an input to the node 515. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, the ANN may be trained using training data. As an example, and not by way of limitation, training data may comprise inputs to the ANN 500 and an expected output. As another example and not by way of limitation, training data may comprise vectors each representing a training object and an expected label for each training object. In particular embodiments, training the ANN may comprise modifying the weights associated with the connections between nodes of the ANN by optimizing an objective function. As an example, and not by way of limitation, a training method may be used (e.g., the conjugate gradient method, the gradient descent method, the stochastic gradient descent) to backpropagate the sum-of-squares error measured as a distance between each vector representing a training object (e.g., using a cost function that minimizes the sum-of-squares error). In particular embodiments, the ANN may be trained using a dropout technique. As an example, and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training the ANN in a particular manner, this disclosure contemplates training the ANN in any suitable manner.

Exemplary embodiments discussed above may provide certain advantages. Though not required to practice aspects of the disclosure, these advantages may include those provided by the following features.

Some embodiments of the system and the method may help in automating the various tasks while employee offboarding.

Some embodiments of the system and the method may be useful in making a structured offboarding procedure for the employees.

Some embodiments of the system and the method may be helpful in seamless collaboration between multiple stakeholders involved in the offboarding process and also in keeping track of the entire process in real time.

Some embodiments of the system and the method may prevent loss and theft of important data of the company.

Although implementations for methods and system for managing offboarding of employees for a company have been described in language specific to structural features and/or methods, it is to be understood that the appended claims are not necessarily limited to the specific features or methods described. Rather, the specific features and methods are disclosed as examples of implementations for managing offboarding of employees for a company.

1. A method for managing offboarding of employees for a company, comprising:
initiating by a processor, a request for offboarding an employee;
extracting, by the processor, employee data comprising employee role, employee connections, and a list of applications used by the employee, from a company database;
extracting, by the processor, application data relating to one or more applications of the list of applications from multiple source, wherein the multiple sources include at least one of: a Single Sign On (SSO) integration, an application integration, a browser extension, a desktop agent, and an expense log integration;
deriving, by the processor, insights for each of the one or more applications from the list of applications, using a first machine learning algorithm wherein the first machine learning algorithm is trained, using recursive learning techniques, on a first training dataset comprising application data of a plurality of employees, application usage patterns of the plurality of the employees, and access rights for the plurality of employees;
determining, by the processor, a set of actions for the one or more applications based on the insights and a set of company rules, wherein the set of company rules include: a set of actions for a set of applications, access rights of an application for an employee based on the employee role, priority of an application based on the access rights; and
automatically scheduling, by the processor, the set of actions for the one or more applications based on the insights, the employee data, and the application data using APIs, wherein scheduling the set of actions comprises:
arranging, by the processor, the one or more applications in a sequence based on a priority of the one or more applications, wherein a second machine learning algorithm is trained, using the recursive learning techniques, to dynamically compute the priority of the one or more applications, wherein the second machine learning algorithm is trained, using the recursive learning techniques, on a second training data set comprising employee data for the plurality of employees, the set of company rules, a set of applications used by the plurality of employees, and priority of each application in the set of applications used by the employees;
receiving feedback, from an error management system, for the sequence of the one or more applications and scheduling the set of actions for the one or more applications, wherein the error management system uses a third machine learning algorithm to ensure completion of the set of actions-end, and wherein the third machine learning algorithm is trained, using the recursive learning techniques, on a third training data set comprising employee data for the plurality of employees, the set of company rules for a plurality of companies, the set of application used by the plurality of employees, and the set of actions for the one or more applications; and
continuously modifying the scheduling for the set of actions based on the feedback.

2. The method of claim 1, wherein the application data comprises licensing details and application usage data.

3. The method of claim 1, wherein the insights comprise a category assigned to each application, access rights, and application usage pattern, and wherein the category is one of “Managed,” “Unmanaged,” and “Restricted”.

4. The method of claim 1, wherein the set of company rules comprises a predefined set of actions for a set of applications.

5. The method of claim 1, wherein the set of actions comprises at least one of resource management, revoke access control, deactivation, and recommend removal.

6. (canceled)

7. The method of claim 1, further comprising;
maintaining a status log of the set of actions, wherein the status log comprises a status of each action of the set of action, and wherein the status is either a completed status or a pending status.

8-9. (canceled)

10. The method of claim 1, wherein the error management system is automatically assigned using the one or more machine learning algorithms trained on the employee data and the insights.

11. The method of claim 7, further comprising:
identifying a cause for the pending status for an action, wherein the cause is at least one of: broken APIs, permissions or security error, and incorrect schedule.

12. The method of claim 11, further comprising reporting the actions having the pending status and the cause to the error management system.

13. The method of claim 1, further comprising;
receiving, from the error management system, a new set of actions for an application not in the set of company rules.

14. The method of claim 1, further comprising;
dynamically modifying the set of company rules based on the new set of actions.

15. A system for managing offboarding of employees for a company, the system comprising:
a memory; and
a processor coupled to the memory, wherein the processor is configured to execute one or more instructions stored in the memory to:
initiate a request for offboarding an employee;
extract employee data comprising employee role, employee connections, a list of applications used by the employee, from a company database;
extract application data relating to one or more applications of the list of applications from multiple sources, wherein the multiple sources include at least one of: a Single Sign On (SSO) integration, an application integration, a browser extension, a desktop agent, and an expense log integration;
derive insights for the one or more applications from the list of applications, using a first machine learning algorithm wherein the first machine learning algorithm is trained, using recursive learning techniques, on a first training dataset comprising application data of a plurality of employees, application usage patterns of the plurality of the employees, and access rights for the plurality of employees;
determine a set of actions for the one or more applications based on the insights and a set of company rule, wherein the set of company rules include: a set of actions for a set of applications, access rights of an application for an employee based on the employee role, priority of an application based on the access rights; and
automatically schedule the set of actions for the one or more applications based on the insights, the employee data, and the application data using APIs, wherein scheduling the set of actions comprises:
arrange the one or more applications in a sequence based on a priority of the one or more applications, wherein a second machine learning algorithm is trained, using the recursive learning techniques, to dynamically compute the priority of the one or more applications, wherein the second machine learning algorithm is trained, using the recursive learning techniques, on a second training data set comprising employee data for the plurality of employees, the set of company rules, a set of applications used by the plurality of employees, and priority of each application in the set of applications used by the employees;
receive feedback, from an error management system, for the sequence of the one or more applications and scheduling the set of actions for the one or more applications, wherein the error management system uses a third machine learning algorithm to ensure completion of the set of actions, wherein the third machine learning algorithm is trained, using the recursive learning techniques, on a third training data set comprising employee data for the plurality of employees, the set of company rules for a plurality of companies, the set of application used by the plurality of employees, and the set of actions for the one or more applications; and
continuously modify the scheduling for the set of actions based on the feedback.

16. The system of claim 15, wherein the application data comprises licensing details and application usage data.

17. The system of claim 15, wherein the insights comprise a category assigned to each application, access rights, and application usage pattern, and wherein the category is one of “Managed,” “Unmanaged,” and “Restricted”.

18. The system of claim 15, wherein the set of company rules comprises a predefined set of actions for a set of applications.

19. The system of claim 15, wherein the set of actions comprises at least one of: resource management, revoke access control, deactivation, and recommend removal.

20-21. (canceled)

22. The system of claim 15, wherein the error management system is automatically assigned using the one or more machine learning algorithms trained on the employee data and the insights.

23. (canceled)

24. The system of claim 15, wherein the processor is further configured to:
receive, from the error management, a new set of actions for an application not in the set of company rules.

25. The system of claim 24, wherein the processor is further configured to dynamically modify the set of company rules based on the new set of actions.

26. A non-transitory computer program product having embodied thereon a computer program for recommending applications for managing offboarding of employees for a company, the computer program product storing one or more instructions for:
initiating, by a processor, a request for offboarding an employee;
extracting, by the processor, employee data comprising employee role, employee connections, a list of applications used by the employee from a company database;
receiving, by the processor, application data relating to one or more applications of the list of applications from multiple sources, wherein the multiple sources include at least one of: a Single Sign On (SSO) integration, an application integration, a browser extension, a desktop agent and an expense log integration;
deriving, by the processor, insights for each of the one or more applications from the list of applications, using a first machine learning algorithm wherein the first machine learning algorithm is trained, using recursive learning techniques, on a first training dataset comprising application data of a plurality of employees, application usage patterns of the plurality of the employees, and access rights for the plurality of employees;
determining, by the processor, a set of actions for the one or more applications based on the insights and a set of company rules, wherein the set of company rules include: a set of actions for a set of applications, access rights of an application for an employee based on the employee role, priority of an application based on the access rights; and
automatically scheduling, by the processor, the set of actions for the one or more applications based on the insights, the employee data, and the application data using APIs, wherein scheduling the set of actions comprises:
arranging, by the processor, the one or more applications in a sequence based on a priority of the one or more applications, wherein a second machine learning algorithm is trained, using the recursive learning techniques, to dynamically compute the priority of the one or more applications, wherein the second machine learning algorithm is trained, using the recursive learning techniques, on a second training data set comprising employee data for the plurality of employees, the set of company rules, a set of applications used by the plurality of employees, and priority of each application in the set of applications used by the employees;
receiving feedback, from an error management system, for the sequence of the one or more applications and scheduling the set of actions of the one or more applications, wherein the error management system uses a third machine learning algorithm to ensure completion of the set of actions and sequence of the one or more applications, and wherein the third machine learning algorithm is trained, using the recursive learning techniques, on a third training data set comprising employee data for the plurality of employees, the set of company rules for a plurality of companies, the set of application used by the plurality of employees, and the set of actions for the one or more applications; and
continuously modifying the scheduling for the set of actions based on the feedback.

27-28. (canceled)

29. The method of claim 13, wherein the third machine learning algorithm provide a suggestion for the new set of actions in case an action from the set of actions cannot be completed for the employee.

30. The method of claim 1, wherein the error management system is assigned, using one or more machine learning algorithms, based on the employee data.
